(19) United States
(12) Patent Application Publication
(10) Pub. No.: US 2002/0078220 A1
(43) Pub. Date: Jun. 20, 2002

(54) System and method for content synchronization over a network

(76) Inventor: Rhys Ryan, San Francisco, CA (US)

Correspondence Address: Thomas C. Webster, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/738,002

(22) Filed: Dec. 14, 2000

(51) Int. Cl. G06F 15/16

(52) U.S. Cl. 709/231; 709/236

(57) ABSTRACT

A computer-implemented method is disclosed comprising: associating a first multimedia clip with synchronization data, the synchronization data identifying Internet objects/content to be transmitted to a client at specified times during playback of the first multimedia clip at the client; transmitting the synchronization data to the client; and streaming the first multimedia clip to the client, the client downloading Internet objects/content identified by the synchronization data at the specified times during playback of the first multimedia clip.

Also disclosed is a segment file comprised of: a multimedia segment; one or more pointers identifying Internet objects/content to be transmitted to a client; and timing data indicating times during playback of the multimedia segment for displaying the Internet objects/content.

### BACKGROUND

1. Field of the Invention

This invention relates generally to the field of digital audio and/or video (hereinafter “audio/video” or “multimedia) delivery systems. More particularly, the invention relates to a system and method for synchronizing the transmission and display of network content with multimedia streaming over a network.

2. Description of the Related Art

Streaming is a technique for transmitting real time audio and/or video content over a network. The purpose of streaming is to provide clients with uninterrupted audio/video content over a connection with limited bandwidth (e.g., a 56K-modem connection). A few seconds of the digital audio/video stream is buffered at the client side before the signal is played back. This buffering technique compensates for momentary delays in packet delivery.

Traditionally, in order to provide clients with a service for streaming audio and/or video data (i.e., audio/video “content”), the end users receiving the audio/video content must have a Web browser (e.g., Netscape Navigator™ or Microsoft Internet Explorer™) with an appropriate browser plug-in installed. A “plug-in” is a supplemental program, generally installed after installation of the Web browser, which provides some additional functionality to the browser. For example, if an audio/video content provider streams audio content to clients using Real Media's™ Real Audio™ streaming format, then before an end user can receive and play back the content, the end user must install a Real Media Audio Player plug-in configured within his/her Web browser.

There are several problems associated with the foregoing arrangement. First, in order to install a plug-in, a user must first select the one which is compatible with his/her system. A plug-in which runs on one browser will not typically run on a different browser. Even for users who are knowledgeable about computers, this process can be somewhat of an annoyance (especially if the user simply wanted to retrieve some quick information from a Web page). In addition, once the user selects the appropriate browser plug-in, the download process for that plug-in may take a significant amount of time, particularly if the user does not have a high-speed connection to the Internet (e.g., 56 k-baud or less).

In addition to the foregoing configuration problems, no built-in mechanisms exist for synchronizing the transmission and display of other types of Internet content with a multimedia stream. As such, accurate synchronization of an audio/video stream with graphic images, text or other types of data can be an extremely complex task—one which may require an extensive understanding of a specialized programming language (e.g., such as the Synchronized Multimedia Integration Language or “SMILE”).

Accordingly, what is needed is a system and method which will provide for the synchronization of various different types of Internet content with a multimedia stream without the need for a complex programming language. What is also needed is a system and method which may be seamlessly implemented on currently existing computer platforms, without the need for additional software support.

### SUMMARY

A computer-implemented method is disclosed comprising: associating a first multimedia clip with synchronization data, the synchronization data identifying Internet objects/content to be transmitted to a client at specified times during playback of the first multimedia clip at the client; transmitting the synchronization data to the client; and streaming the first multimedia clip to the client, the client downloading Internet objects/content identified by the synchronization data at the specified times during playback of the first multimedia clip.

Also disclosed is a segment file comprised of: a multimedia segment; one or more pointers identifying Internet objects/content to be transmitted to a client; and timing data indicating times during playback of the multimedia segment for displaying the Internet objects/content.

### BRIEF DESCRIPTION OF THE DRAWINGS

A better understanding of the present invention can be obtained from the following detailed description in conjunction with the following drawings, in which:

FIG. 1 illustrates an exemplary network architecture used to implement elements of the invention.

FIG. 2 illustrates an exemplary computer architecture used to implement elements of the invention.

FIG. 3 illustrates one embodiment of the invention for distributing audio/video content to a client.

FIG. 4 illustrates a Java applet implemented in one embodiment of the invention.

FIG. 5 illustrates one embodiment of a system and method for content synchronization over a network.

FIG. 6 illustrates a segment file according to one embodiment of the invention.

### DETAILED DESCRIPTION

In the following description, for the purposes of explanation, numerous specific details are set forth in order to provide a thorough understanding of the invention. It will be apparent, however, to one skilled in the art that the invention may be practiced without some of these specific details. In other instances, well-known structures and devices are shown in block diagram form to avoid obscuring the underlying principles of the invention.

### An Exemplary Network Architecture

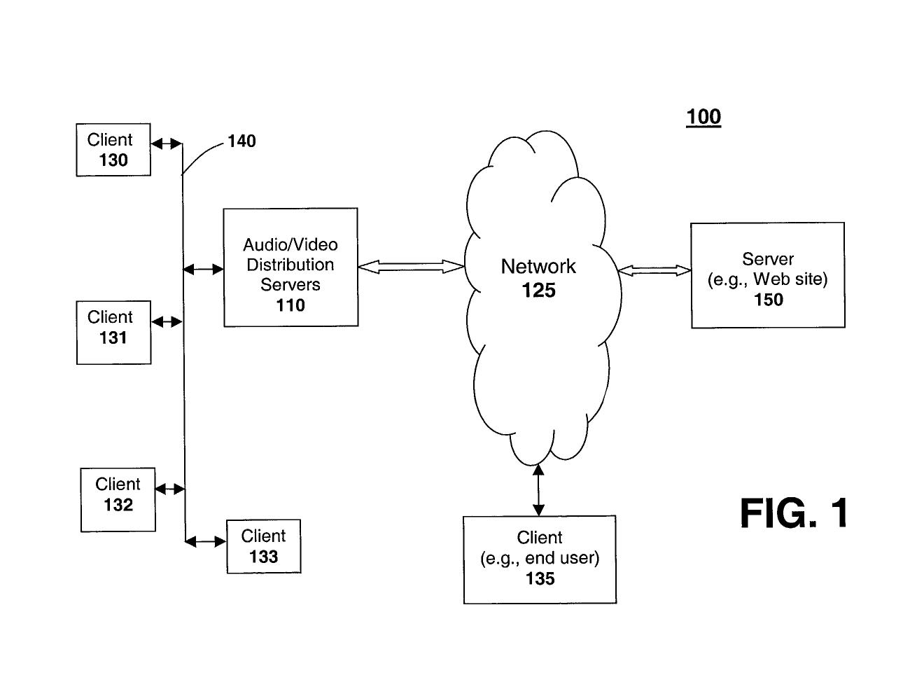

Elements of the present invention may be included within a client-server based system 100 such as that illustrated in FIG. 1. According to the embodiment depicted in FIG. 1, one or more servers 110, 150 communicate to one or more clients 130-133, 135. The clients 130-133, 135 may transmit and receive data from the servers 110, 150 over a variety of communication media including (but not limited to) a local area network 140 and/or a larger network 125 (e.g., the Internet). Alternative communication channels such as wireless communication via satellite broadcast (not shown) are also contemplated within the scope of the present invention.

The servers 110, 150 may include one or more databases for storing digital audio and/or video data. The databases may also store specific client data (e.g., information on how frequently a particular client logs in to server 110 and that client's preferences) and/or more general data. The database in one embodiment runs an instance of a Relational Database Management System (RDBMS), such as Microsoft™ SQL-Server, Oracle™ or the like.

A client may interact with and receive feedback from servers 110, 150 using various different communication devices and/or protocols. In one embodiment, the client logs in to servers 110, 150 via client software. The client software may include a Java-enabled browser application such as Netscape Navigator™ or Microsoft Internet Explorer,™ and may communicate to servers 110, 150 via the Hypertext Transfer Protocol (hereinafter “HTTP”). In other embodiments included within the scope of the invention, clients may communicate with servers 110, 150 via cellular phones and pagers (e.g., in which the necessary software is embedded in a microchip), handheld computing devices, and/or touch-tone telephones. In addition, the present invention may be used with any device connectable to the Internet in a direct or wireless connection.

### An Exemplary Computer Architecture

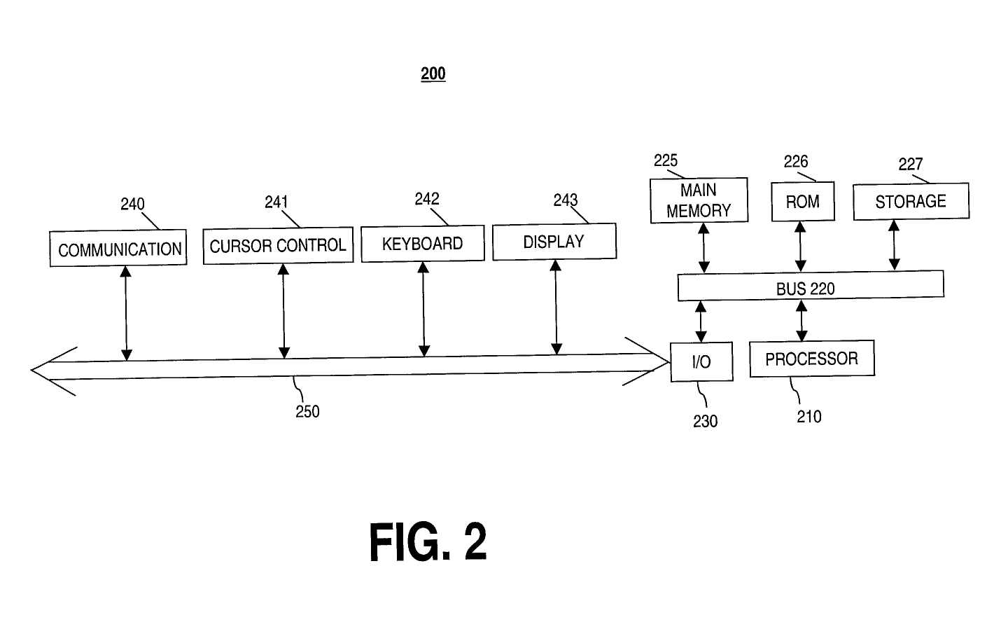

Having briefly described an exemplary network architecture which employs various elements of the present system and method, a computer system 200 representing exemplary clients 130-133, 135 and/or servers 110, 150 in which elements of the system and method may be implemented will now be described with reference to FIG. 2.

One embodiment of a computer system 200 comprises a system bus 220 for communicating information, and a processor 210 coupled to bus 220 for processing information. Computer system 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Computer system 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Computer system 200 can also be coupled to a second I/O bus 250 via and I/O interface 230. A plurality of I/O devices may be coupled to I/O bus 250, including a display device 243, an input device (e.g., an alphanumeric input device 242 and/or a cursor control device 241).

The communication device 240 may comprise a modem, a network interface card, or other well known interface device, such as those used for coupling to Ethernet, token ring, or other types of networks. In any event, in this manner, the computer system 200 may be coupled to a number of servers via a conventional network infrastructure, such as a company's local area network 140 and/or the larger network 125, for example.

### Embodiments of a System and Method for Content Synchronization

In one embodiment, the owner/operator of the Internet server 150 is a customer of the owner/operator of audio/video distribution servers 110, and client 135 is an end user (e.g., a user dialing out to the Internet or connecting to the Internet via a broadband connection such as digital subscriber line). In this embodiment, the owner of the Internet server 150 may contract with the owner of the audio/video distribution servers 110 to provide audio and/or video functionality for the Internet site supported by the Internet server 150. For example, server 150 may represent an e-commerce customer such as Ticket Master™ Online or The Gap™ Online and the multimedia content used by these customers may be provided by the audio/video distribution servers 110.

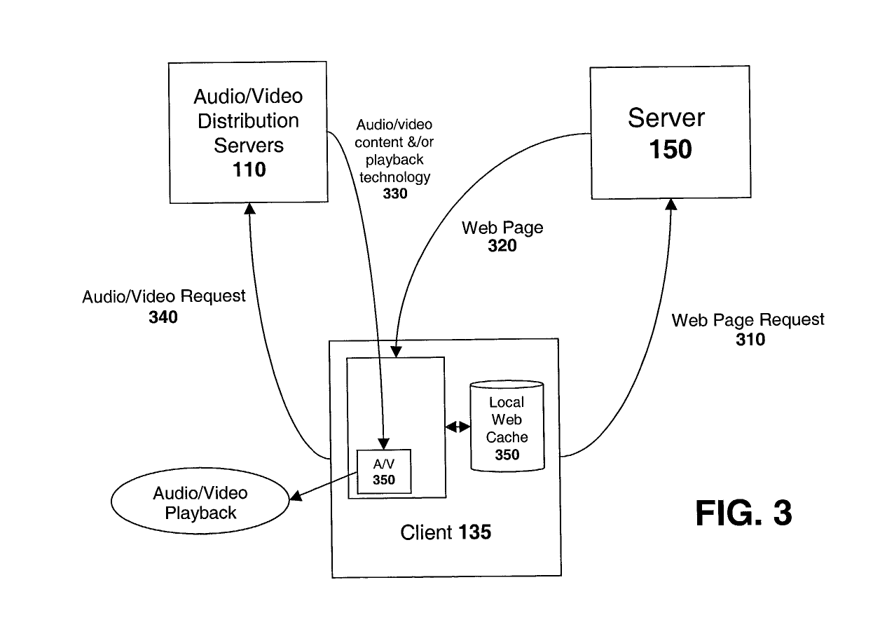

With the foregoing business relationship in mind, FIG. 3 illustrates client 135 communicating over network 125 to audio/video distribution servers 110 and server 150. In one embodiment of the system and method, client 135 initially makes a Web page request 310 from server 150 (e.g., by clicking on a link to that Web page) and, in response, server 150 transmits the requested Web page 320 to client 135. The Web page request 310 may contain more information than a simple Web page address. For example, if client 135 has previously visited server 150, then cookie data identifying client 135 may also be transmitted to server 150. Server 150 may then transmit a Web page 320 to client 135 which contains information uniquely tailored to client 135's preferences. For example, server 150 may be a Ticket Master server from which client 135 has purchased numerous tickets to alternative rock concerts. As such, the Web page 320 transmitted to client 135 may contain specific information relating to upcoming alternative rock concerts, shows, or featured artists.

Audio/video objects 350 may be embedded in Web page 320 which direct audio and/or video associated with the Web page 320 (or components thereof) to be downloaded from the audio/video distribution servers 110 when the Web page 320 is downloaded to the client 135 (or shortly thereafter). In addition, in one embodiment, the audio/video objects 350 may include audio/video streaming, decoding and playback technology (e.g., a Java audio playback applet). This is illustrated in FIG. 3 as an audio/video request 340 from client 135 to the audio/video distribution servers 110, and subsequent audio/video content 330 distribution (with or without playback technology).

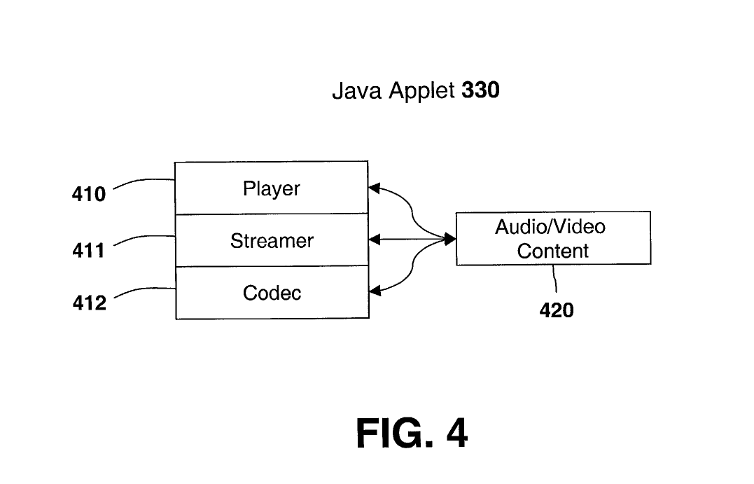

As illustrated in greater detail in FIG. 4, one embodiment of playback technology includes a Java applet which is comprised of an audio/video player module 410, a streamer module 411, a codec module 412 and the underlying audio/video content 420. The codec module 412 in one embodiment uses an advanced pulse code modulation (“ADPCM”) codec for compressing/decompressing audio/video content. Accordingly, when audio/video content is to be delivered to a particular end-user, the codec is transmitted along with the content. In one embodiment, the player 410 is transmitted to client 135 in a first network transaction. Secondly, the codec 412 and streamer 411 are transmitted to the client 135. Finally, the content 420 is streamed to the client 135 for decompression by codec 412.

In this embodiment, because the player 410 and related modules 411-412 are written in Java, these programs are architecture-neutral. Accordingly, they can be executed on any system which includes a Java virtual machine (virtually all Web browser-equipped machines do). In contrast, browser plug-ins used in prior audio and video streaming systems are platform-dependent (e.g., a plug-in developed for Internet Explorer will not necessarily run on Netscape Navigator and a plug-in developed for a Macintosh™ computer will not run on a PC).

In addition, because Java was designed to create compact programs, the Java applet 330 may be quite small. For example, in one embodiment, the Java applet 330 is slightly more than 5 k-bytes in size, making it ideal for streaming applications where a short transmission time is necessary. One embodiment of the player module 410, streamer module 411, and/or codec module 412 is described in the co-pending U.S. patent applications entitled “A System and Method for Streaming Data in Java,” Ser. No. 09/388,634; and “A System and Method for Providing Audio/Video Content delivery Over a Network,” Ser. No. 09/377,883 which are assigned to the assignee of the present application and which are incorporated herein by reference.

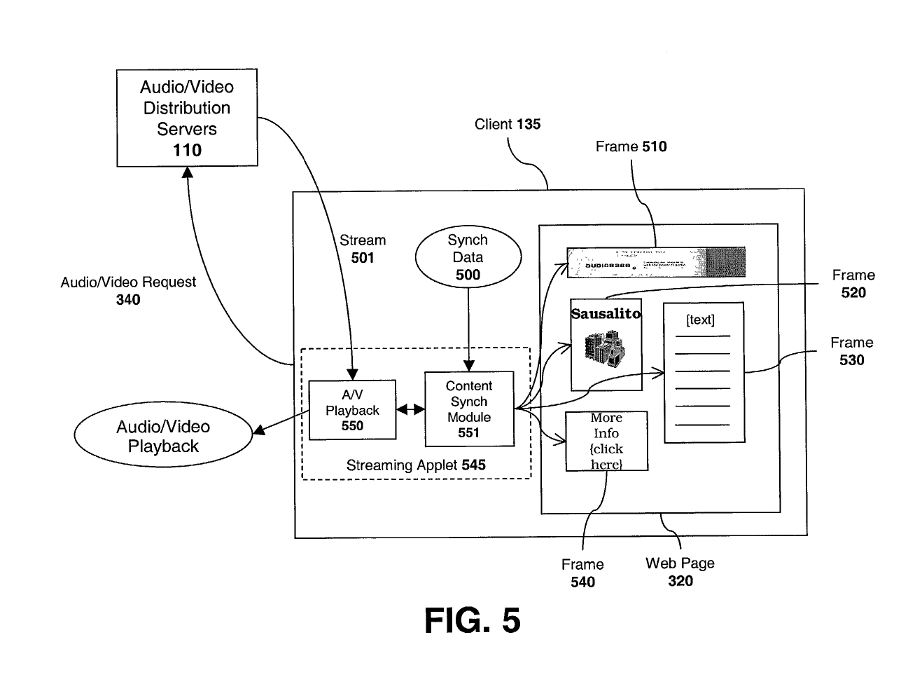

Regardless of the particular type of audio/video streaming technology employed, one embodiment of the invention includes support for content synchronization. More specifically, referring to FIG. 5, a content synchronization module 351 executed on the client 135 (e.g., running within a Java applet 545) synchronizes other types of Web objects (e.g., text, video, graphics) with the incoming audio/video stream 501. As illustrated, the synchronized objects may be rotated within a plurality of object frames 510, 520, 530 and 540 embedded within a Web page 320. However, it should be noted that various other non-embedded Web objects/content may be triggered by the audio/video stream while still complying with the underlying principles of the invention.

In operation, as the audio/video stream 501 is rendered at the client 135, the content synchronization module 551 directs new objects into each frame at various predefined points in time. The objects directed into each frame may be related to the underlying content on the Web page 320. For example, the embodiment illustrated in FIG. 5 shows a Web page 320 containing information associated with a particular city: Sausalito, Calif. Accordingly, as the audio/video stream 501 is played back at the client 135, the content synchronization module 551 may direct several different advertisements within frame 510 for companies located in and around Sausalito. Each advertisement may be inserted into the frame 510 for a specified period of time. For example, if the audio/video stream 501 is 360 seconds in duration, the content synchronization module 551 may direct six different ads into the frame 510, each for a duration of 60 seconds (i.e., while the audio/video stream is playing). Similarly, the content synchronization module 551 may rotate text associated with Sausalito into frame 530 (e.g., describing different aspects of the city); pictures of Sausalito in frame 520; and links to additional related information in frame 540. Various other Internet object types (e.g., chat room links, newsgroup links, . . . etc) may be inserted into the embedded frames 510, 520, 530 and 540 while still complying with the underlying principles of the invention.

Synchronization data 500 comprised of object pointers (e.g., HTTP addresses) identifying each object and timing data for object insertion may be embedded within the audio/video stream 501 itself. Alternatively, or in addition, the synchronization data 500 may be transmitted to the client 135 separately, either directly from the audio/video distribution servers 110 or from one or more other Internet servers (e.g., server 150 from which the underlying Web page 320 was transmitted). In one embodiment, the synchronization data 500 may be programmed by the end user and stored directly on the client 135. The underlying principles of the invention may be implemented using various other sources of synchronization data 500.

In one embodiment, the synchronization data 500 may be generated dynamically, based on the unique preferences of the end-user requesting the Web page 320 or other Web object/content. As described briefly above, the end user's preferences may be identified based on cookie data transmitted from the client 135 to the Web server 150 and/or the audio/video distribution servers 110. More specifically, the cookie data may be utilized by server-side code such as a Common Gateway Interface (“CGI”) program to dynamically construct the synchronization data 500 (e.g., particular object pointers/addresses and timing data) based on the user's preferences. For example, if the user is identified as an individual who is interested in outdoor activities, the CGI program may generate synchronization data 500 which includes pointers to outdoor-related content (e.g., camping/hiking equipment, sport-utility vehicles, . . . etc).

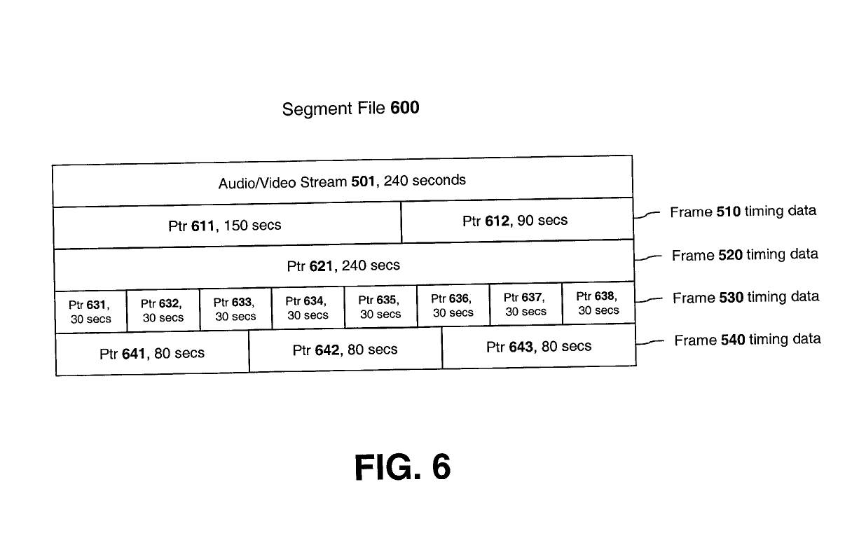

One particular embodiment of synchronization data 500, illustrated in FIG. 6, is comprised of a segment file 600 (or a group of segment files) including an audio/video stream of a specified duration (e.g., 240 seconds in the embodiment illustrated in FIG. 6), and associated frame timing data. In one embodiment, the frame timing data includes pointers 611-612, 621, 631-638, 641-643 to particular Internet objects/content to be transmitted/displayed in respective frames 510, 520, 530 and 540 while the audio/video stream 501 is rendered at the client 135. Each of the pointers 611-612, 621, 631-638, and 641-643 have a time period associated therewith, defining the length of time the object/content identified by the pointer should be displayed within its respective frame. For example, in the particular embodiment illustrated in FIG. 6, an Internet object identified by pointer 611 will be displayed in frame 510 for a duration of 150 seconds followed by an Internet object identified by pointer 612 for a period of 90 seconds. Virtually any type of Internet object capable of being identified by a pointer (e.g., a network address) may be identified and associated with a frame within the segment file 600. Moreover, the Internet objects 510, 520, 530,540, the Web pages 320 and/or the streamed multimedia content 501 may all be transmitted from a single server or from multiple servers, depending on the configuration (e.g., depending on the network addresses to which the pointers point).

In one embodiment of the invention event “hooks” are embedded within the multimedia stream itself, rather than within a segment file 600. The event hooks identify internet objects (e.g., such as those described above with respect to the segment file embodiments) to be displayed at specified points during playback of the multimedia stream. In one embodiment, extraction logic residing on the client extracts and processes the event hooks and object/pointer data, thereby causing the frames and/or Web pages to react to the embedded events as they are received. In one embodiment, a timer value may also be transmitted with the embedded data, indicating a particular time during playback of the multimedia stream at which the identified Internet objects should be displayed. Accordingly, in this embodiment, the embedded event hooks and related data would not be required to trigger as soon as they are received at the client 135.

In one embodiment, the pointers and associated time periods contained within the segment file may be dynamically selected based on the preferences of the end-user. For example, as described above, the user's cookie data (e.g., stored on the user's client 135) may be utilized by a CGI program (e.g., running on the audio/video distribution servers 110 and/or the Web server 150) to dynamically insert pointers and time periods into segment file 600 based on the user's preferences. Thus, if the cookie data indicates that the user is from a particular geographical region in the country (e.g., the west coast), the CGI program may insert pointers identifying objects/content associated with that region (e.g., San Francisco bay area cities).

In one embodiment, the segment file 600 may also include positional data (not shown) indicating where each frame should be positioned within the Web page 320. Alternatively, if the identified objects are not embedded within a Web page the positional data may indicate where the frames should be positioned on the client's 135's display. In addition, one embodiment of the segment file 600 also includes dimensional data specifying the area to be occupied by the identified object. Various other types of object-oriented data may be included within the segment file 600 while still complying with the underlying principles of the invention.

Embodiments of the present invention include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

Elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A computer-implemented method comprising:
associating a first multimedia clip with synchronization data, said synchronization data identifying Internet objects/content to be transmitted to a client at specified times during playback of said first multimedia clip at said client;
transmitting said synchronization data to said client; and
streaming said first multimedia clip to said client, said client downloading said Internet objects/content identified by said synchronization data at said specified times during playback of said first multimedia clip.

2. The method as in claim 1 further comprising:
identifying one or more preferences of a user of said client; and
generating particular synchronization data based on said user's preferences.

3. The method as in claim 2 wherein said user's preferences are identified by reading cookie data transmitted from said client.

4. The method as in claim 2 wherein generating of said particular synchronization data is performed by a CGI program.

5. The method as in claim 1 wherein one of said objects/content is an advertisement transmitted from an advertisement server.

6. The method as in claim 1 further comprising:
transmitting a multimedia playback module to said client for playing back said first multimedia clip.

7. The method as in claim 6 wherein said multimedia playback module is a Java applet.

8. The method as in claim 1 wherein said synchronization data is comprised of one or more pointers having one or more time periods associated therewith, said time periods indicating how long Internet objects/content identified by said one or more pointers will be displayed at said client.

9. The method as in claim 8 wherein each of said pointers are associated with a frame defined within a Web page downloaded by said client, said Internet objects/content identified by said pointers being displayed in said frame.

10. The method as in claim 8 wherein said synchronization data is further comprised of positional data indicating a position where said Internet objects/content will be displayed on said client.

11. The method as in claim 1 further comprising:
associating a second multimedia clip with second synchronization data, said second synchronization data identifying Internet objects/content to be transmitted to a client at specified times during playback of said second multimedia clip at said client;
transmitting said second synchronization data to said client; and
streaming said second multimedia clip to said client, said client downloading said Internet objects/content identified by said second synchronization data at said specified times during playback of said first multimedia clip.

12. An article of manufacture including a sequence of instructions which, when executed by a processor, cause said processor to:
associate a first multimedia clip with synchronization data, said synchronization data identifying Internet objects/content to be transmitted to a client at specified times during playback of said first multimedia clip at said client;
transmit said synchronization data to said client; and
stream said first multimedia clip to said client, said client downloading said Internet objects/content identified by said synchronization data at said specified times during playback of said first multimedia clip.

13. The article of manufacture as in claim 12 comprising additional instructions which cause said processor to:
identify one or more preferences of a user of said client; and
generate particular synchronization data based on said user's preferences.

14. The article of manufacture as in claim 13 wherein said user's preferences are identified by reading cookie data transmitted from said client.

15. The article of manufacture as in claim 13 comprising additional instructions which cause said processor to:
execute a CGI program to generate said particular synchronization data.

16. The article of manufacture as in claim 12 wherein one of said objects/content is an advertisement transmitted from an advertisement server.

17. The article of manufacture as in claim 12 comprising additional instructions which cause said processor to:
transmit a multimedia playback module to said client for playing back said first multimedia clip.

18. The article of manufacture as in claim 6 wherein said multimedia playback module is a Java applet.

19. The article of manufacture as in claim 12 wherein said synchronization data is comprised of one or more pointers having one or more time periods associated therewith, said time periods indicating how long Internet objects/content identified by said one or more pointers will be displayed at said client.

20. The article of manufacture method as in claim 19 wherein each of said pointers are associated with a frame defined within a Web page downloaded by said client, said Internet objects/content identified by said pointers being displayed in said frame.

21. The method as in claim 19 wherein said synchronization data is further comprised of positional data indicating a position where said Internet objects/content will be displayed on said client.

22. A segment file comprised of:
a multimedia segment;
one or more pointers identifying Internet objects/content to be transmitted to a client; and
timing data indicating times during playback of said multimedia segment for displaying said Internet objects/content.

23. The segment file as in claim 22 further comprising:
frame data identifying one or more frames in which said Internet objects/content are to be displayed.

24. The segment file as in claim 22 further comprising:
positional data indicating a position on a display device of a client for displaying said Internet objects/content.

25. The segment file as in claim 22 wherein one of said pointers is an HTTP address.
